(19) United States
(12) Patent Application Publication
(10) Pub. No.: US 2007/0148506 A1
(43) Pub. Date: Jun. 28, 2007

(54) METHOD OF CALCULATING FUEL CONCENTRATION IN A LIQUID FUEL CELL

(76) Inventors: Yu-Ren Chiou, Taipei (TW); Kuen-Sheng Shen, Taipei (TW); Shin-Jung Lian, Taipei (TW); Jia-Hung Weng, Taipei (TW)

Correspondence Address: G. LINK CO., LTD., 3550 BELL ROAD, MINOOKA, IL, 60447, US

(21) Appl. No.: 11/608,007

(22) Filed: Dec. 7, 2006

(30) Foreign Application Priority Data
Dec. 9, 2005 (TW) 094143509

(51) Int. Cl. H01M 8/04

(52) U.S. Cl. 429/13; 429/22

(57) ABSTRACT

A method of calculating fuel concentration in a liquid fuel cell comprises the following steps. One or more fuels with different known concentrations are separately provided for the liquid fuel cell such that the liquid fuel cell performs electrochemical reactions and generates power with various conditions having different known concentrations of fuels. An electrical load is provided to electrically couple with the liquid fuel cell, and a voltage (V) of the electrical load is changed. A plurality of physical parameters are produced when the liquid fuel cell is operated with fuels having known concentrations are respectively measured and recorded, and three of the physical parameters are selected to construct a corresponding three-dimensional measuring space. An interpolation means is generated based on the measuring space to estimate an unknown fuel concentration. At least three instant physical parameters are measured when a fuel with an unknown concentration is provided for the liquid fuel cell to react and generate power, and the interpolation means is used to calculate a current fuel concentration in the liquid fuel cell.

### FIELD OF THE INVENTION

The present invention relates to a concentration meter, and more particularly, to a method of calculating fuel concentration, which is applied to a liquid fuel cell.

### BACKGROUND OF THE INVENTION

Conventionally, the fuel concentration of a liquid fuel cell, such as a direct methanol fuel cell (DMFC), is measured by a concentration sensor. However, the concentration sensor needs to be scaled down for a more compact DMFC. Otherwise, it is not possible to dispose the concentration sensor into a miniaturized DMFC even though such a sensor can detect the concentration of fuel.

In view of the aforesaid disadvantages, a method to calculate fuel concentration in a liquid fuel cell is required. The method provided by the applicant is regarded as a virtual fuel concentration sensor for measuring the concentration of fuel.

### SUMMARY OF THE INVENTION

It is a primary object of the invention to provide a method of calculating fuel concentration, by which the instant fuel concentration in a liquid fuel cell during its electrochemical reactions is measured without using a real concentration meter.

It is another object of the invention to provide a method of calculating fuel concentration substituting for a real concentration meter. This method can estimate the fuel concentration in a liquid fuel cell as the liquid fuel cell performs electrochemical reactions.

In accordance with the aforesaid object of the invention, a method of calculating fuel concentration in liquid fuel cells is disclosed. The method comprises the following steps of: (A) separately providing one or more fuels with different known concentrations for the liquid fuel cell such that the liquid fuel cell performs electrochemical reactions and generates power with various conditions having different known concentrations of fuels; (B) providing an electrical load to electrically connect with the liquid fuel cell, and changing a voltage (V) of the electrical load; (C) respectively measuring and recording a plurality of physical parameters produced when the liquid fuel cell is operated with the fuels of known concentrations in step (B), and selecting three of the physical parameters to construct a corresponding three-dimensional measuring space; (D) generating an interpolation means based on the three-dimensional measuring space for calculating an unknown fuel concentration in the liquid fuel cell; and (E) measuring at least three physical parameters selected in step (C) when a fuel with an unknown concentration is provided for the liquid fuel cell to react and generate power, and then using the interpolation means to calculate a current fuel concentration in the liquid fuel cell.

### BRIEF DESCRIPTION OF THE DRAWINGS

The foregoing aspects, as well as many of the attendant advantages and features of this invention will become more apparent by reference to the following detailed description, when taken in conjunction with the accompanying drawings, wherein:

FIG. 1 is a flow chart of calculating fuel concentration in a liquid fuel cell system according to an embodiment of the invention;

FIG. 2 illustrates the structure of a liquid fuel cell system constructed for verifying the method in accordance with an embodiment of the invention;

FIG. 3 is a graph of equi-concentration curves computed by a 3-D measuring space with various known fuel concentrations based on the method of calculating fuel concentration in accordance with an embodiment of the invention;

FIG. 4 is a flow chart of generating an interpolation means according to an embodiment of the invention; and

FIG. 5 shows the profile of current related to time in a liquid fuel cell system of FIG. 2.

### DETAILED DESCRIPTION OF THE INVENTION

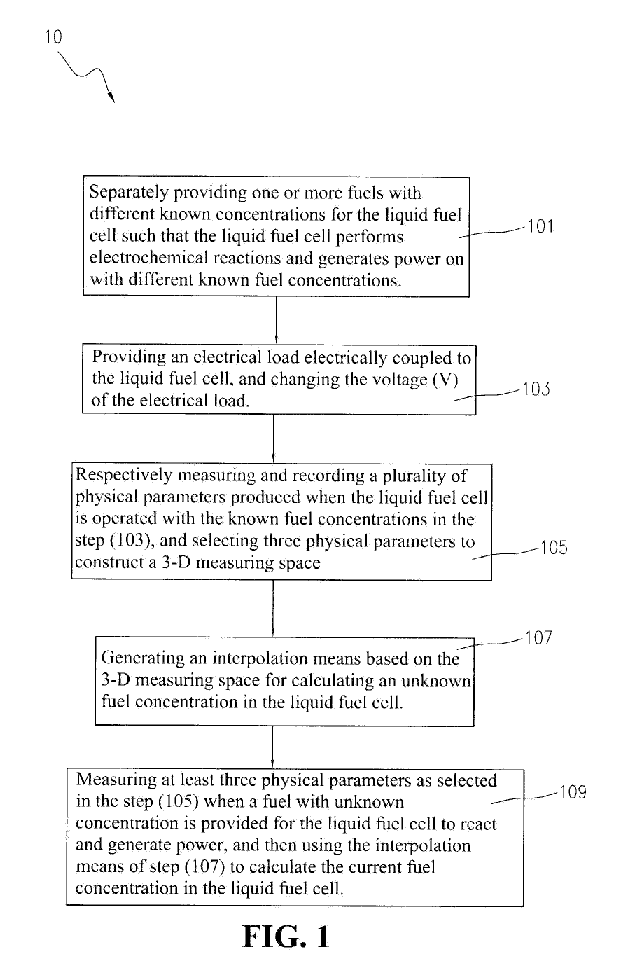

FIG. 1 is a flow chart of calculating fuel concentration in a liquid fuel cell system according to an embodiment of the invention. The method 10 is provided for calculating the present concentration of fuel in a liquid fuel cell 20 without the need of a real concentration meter. The method 10 for calculating fuel concentration includes steps 101 through 109, which are respectively described hereinafter.

In step 101, one or more fuels with different known concentrations are separately supplied for the liquid fuel cell 20, and then the liquid fuel cell 20 performs electrochemical reactions and generates power in various conditions due to different known concentrations of fuel.

Step 103 is performed to provide an electrical load 22 to electrically couple the liquid fuel cell 20, and to change the voltage (V) of load 22.

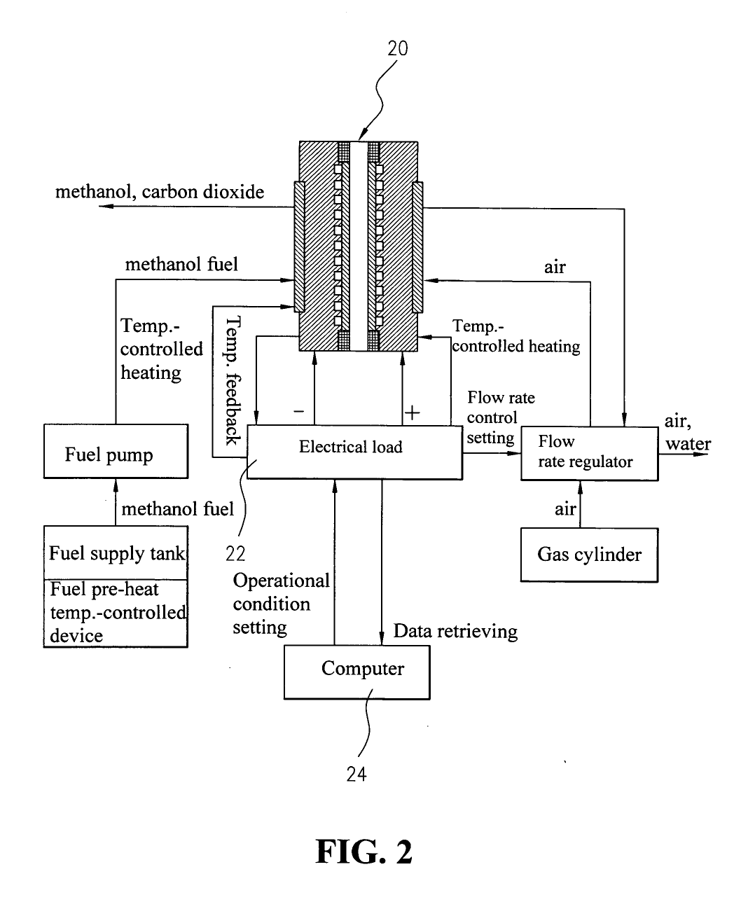

In step 101, fuels with different known concentrations are separately provided for the liquid fuel cell 20 so that the liquid fuel cell 20 has several known concentrations to perform electrochemical reactions. In order to measure the required physical properties conveniently, a liquid fuel cell system that matches the method 10 is provided with reference to FIG. 2. In FIG. 2, the liquid fuel cell 20 may be a bipolar liquid fuel cell, and more specifically, a direct methanol fuel cell DMFC fabricated by printed circuit board (PCB) processes. Additionally, in the step 103, the voltage (V) of the load 22 in FIG. 2 ranges from 0 volts to 0.7 volts, while variation in the voltage of the load 22 (V) ranges between 0.02 volts and 0.5 volts.

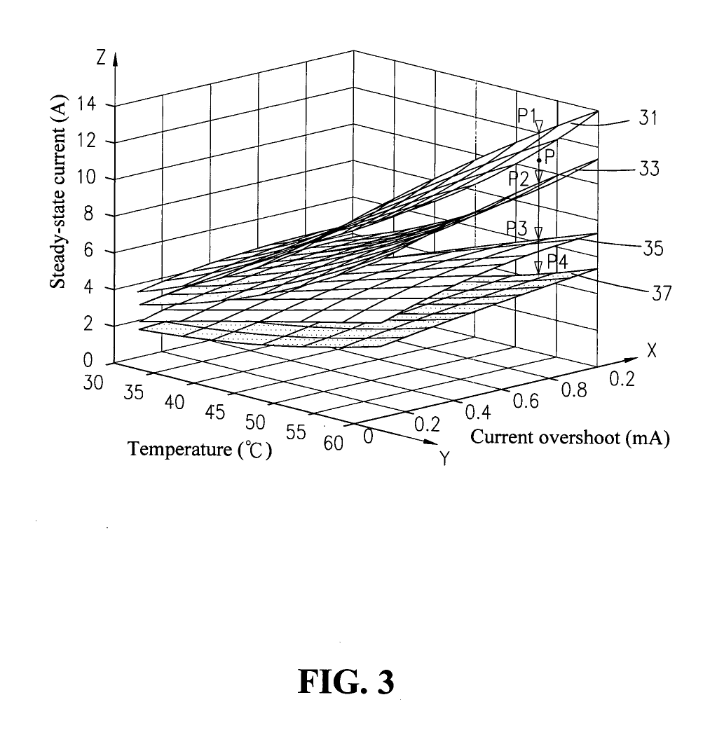

Step (105) is performed to measure and record the physical properties or parameters produced when the liquid fuel cell 20 is operated with fuels of different known concentrations in step 103, and to select three kinds of physical properties for constructing a corresponding three-dimensional (3-D) measuring space. On the condition having a known fuel concentration in step 105, parameters of temperature, steady-state current, current overshoot, and meta-state current for liquid fuel cell 20 may be measured and recorded; wherein the parameter of current overshoot is estimated from the absolute value of the difference between the parameters of meta-state current and steady-state current. In one preferred embodiment of the invention, a 3-D measuring space corresponding to the liquid fuel cell 20 is created using three parameters, i.e. parameters of temperature, steady-state current and current overshoot. As each fuel with known concentration is supplied for the liquid fuel cell system and the liquid fuel cell 20 performs electrochemical reactions accordingly, the varying parameters of temperature, steady-state current and current overshoot are measured and recorded. These parameters are also transferred to a computer 24 shown in FIG. 2. Next, the computer 24 processes the received information and generates a 3-D measuring space corresponding to the known fuel concentration and the parameters of temperature. steady-state current and current overshoot. FIG. 3 shows a graph of equi-concentration curves computed by a 3-D measuring space with various known fuel concentrations according to an embodiment of the invention. Referring to FIG. 3, the equi-concentration curve 31 may be obtained by means of a fuel with known concentration C₁. The X-axis represents the parameter of current overshoot; the Y-axis represents temperature; the Z-axis represents the steady-state current. Similarly, the equi-concentration curves 33, 35, 37 may individually result from different known concentrations C₂, C₃, C₄.

The known concentration of fuels in the step 105 may be from 2v% to 8v%. The extent of concentration varies with the type of the membrane electrode assembly (MFA). The measured and recorded temperature preferably resides within 10° C. and 80° C.

Step 107 is performed to generate an interpolation means based on the 3-D measuring space, which is used to calculate unknown fuel concentrations in the liquid fuel cell 20. In step 107, since each equi-concentration curve of the 3-D measuring space has been plotted, the unknown concentration of fuels can be figured out by using the interpolation means. Step 109 is performed to measure at least three parameters as those selected in step 105, such as parameters of temperature, steady-state current and current overshoot, when a fuel with unknown concentration is provided for a liquid fuel cell to react and generate power, then calculate the current fuel concentration in the liquid fuel cell using the interpolation means constructed in step 107.

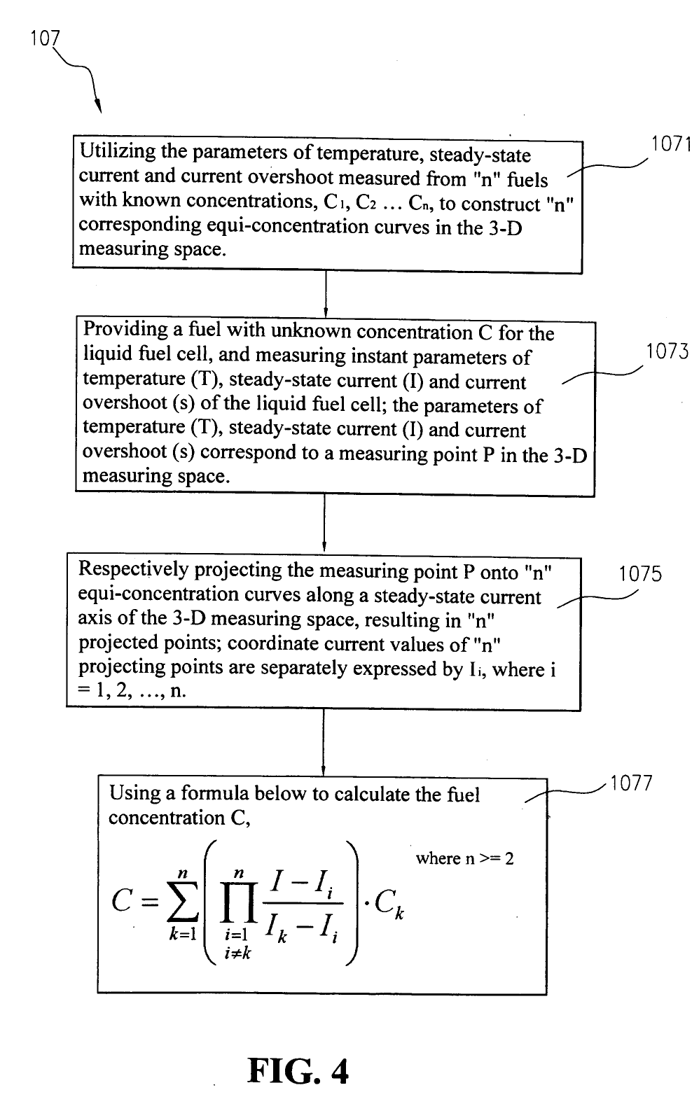

FIG. 4 is a flow chart of generating an interpolation means according to an embodiment of the invention. Step 1071 utilizes the parameters of temperature, steady-state current and current overshoot resulting and measured from “n” kinds of fuels with known concentrations C₁, C₂, . . . ,Cₙ to construct “n” items of corresponding equi-concentration curves in the 3-D measuring space. For example, the equi-concentration curve 31 shown in FIG. 3 is generated as the concentration equals C₁, in the step 1071. Step 1073 is used to provide a fuel with unknown concentration C for the liquid fuel cell 20, and to measure the current temperature (T), steady-state current (I) and current overshoot (σ) of the liquid fuel cell 20 during its electrochemical reactions. Such measured parameters of temperature (T), steady-state current (I) and current overshoot (σ) correspond to a coordinate point in the 3-D measuring space. The coordinate point is regarded as a measuring point P for estimating the unknown concentration as illustrated in FIG. 3.

In step 1075, the measuring point P is projected onto the respective “n” items of equi-concentration curves along the steady state current axis of the 3-D measuring space (i.e. Z-axis), resulting in “n” projecting points, such as P₁, P₂, P₃, P₄, . . . in FIG. 3; wherein coordinate values of steady-state current for these “n” projecting points are expressed by Iᵢ, and i=1, 2, . . . , n. Step 1077 uses the following formula to calculate the fuel concentration C:

$$C = {\sum }_{k = 1}^{n} ( {\prod }_{{i = 1}_{i \neq k}}^{n} \frac{I - {I}_{i}}{{I}_{k} - {I}_{i}} ) \cdot {C}_{k}$$

wherein n≧2.

After performing steps 101 through 105, method 10 can determine the equi-concentration curves regarding to liquid fuel cell 20. Then, step 107 and step 109 may be performed by programming codes, i.e. compiling the equi-concentration curves and the above formula for a processor (not shown) of liquid fuel cell 20.

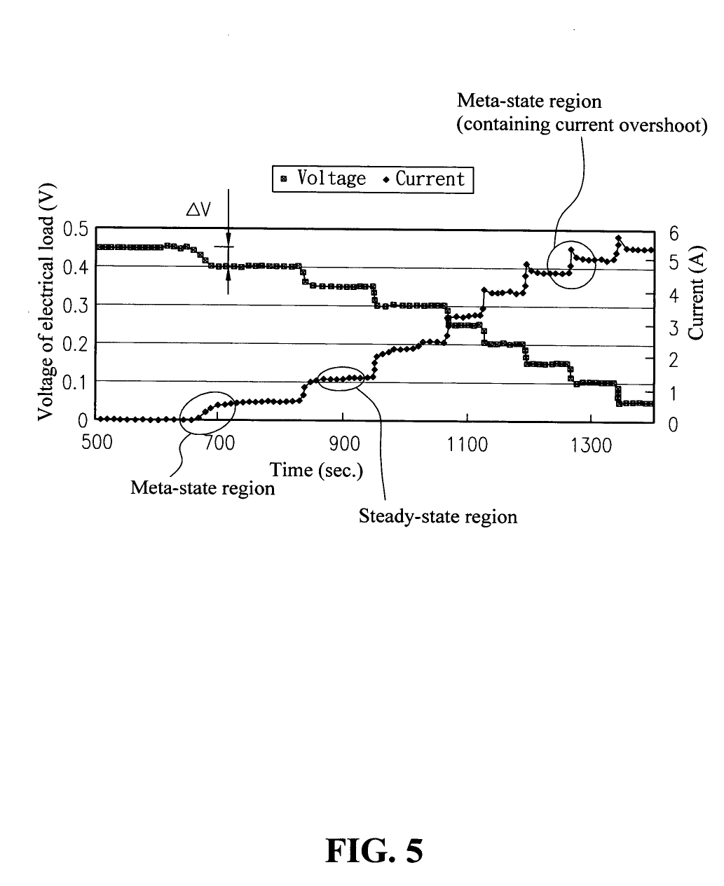

The aforementioned method 10 is regarded as a virtual concentration sensor because an unknown fuel concentration can be obtained by creating the equi-concentration curves in the 3-D measuring space from variation in the voltage of load 22, then the temperature, the steady-state current (as shown in the steady-state region of FIG. 5), and the current overshoot (as shown in the meta-state region of FIG. 5), and thereafter, by calculating an insertion value. Hence, the application is novel and unobvious.

While the invention has been particularly shown and described with reference to the preferred embodiments thereof, these are, of course, merely examples to help clarify the invention and are not intended to limit the invention. It will be understood by those skilled in the art that various changes, modifications, and alterations in form and details may be made therein without departing from the spirit and scope of the invention, as set forth in the following claims.

What is claimed is:

1. A method of calculating a fuel concentration in a liquid fuel cell, the method comprising steps of:
(A) separately providing one or more fuels with different known concentrations for the liquid fuel cell such that the liquid fuel cell performs electrochemical reactions and generates power with various conditions having different known concentrations of fuel;
(B) providing an electrical load to electrically connect with the liquid fuel cell, and changing a voltage (V) of the electrical load;
(C) respectively measuring and recording a plurality of physical parameters produced when the liquid fuel cell is operated with the fuels of the known concentrations in step (B), and selecting three of the physical parameters to construct a corresponding three-dimensional measuring space;
(D) generating an interpolation means based on the three-dimensional measuring space for calculating an unknown fuel concentration in the liquid fuel cell; and
(E) measuring at least three physical parameters as same as the physical parameters selected in the step (C) when a fuel with an unknown concentration is provided for the liquid fuel cell to react and generate power, and then using the interpolation means of step (D) to calculate a current fuel concentration in the liquid fuel cell.

2. The method of claim 1, wherein each known concentration of fuels provided in step (B) ranges between 2v% and 8v%.

3. The method of claim 1, wherein the physical parameters selected in step (C) comprise a parameter of temperature, a parameter of steady-state current, a parameter of current overshoot, and a parameter of meta-state current, wherein the parameter of current overshoot is estimated from an absolute value of a difference between the parameter of meta-state current and the parameter of a steady-state current.

4. The method of claim 3, wherein the parameter of temperature recorded in step (C) ranges between 10° C. and 80° C.

5. The method of claim 1, wherein the voltage (V) of the electrical load ranges between 0 volt and 0.7 volts.

6. The method of claim 1, wherein a variation in the voltage of the electrical load (V) ranges between 0.02 volts and 0.5 volts.

7. The method of claim 1, wherein the interpolation means is implemented by programming codes.

8. The method of claim 1, wherein the liquid fuel cell is a bipolar liquid fuel cell.

9. The method of claim 1, wherein the liquid fuel cell is a liquid fuel cell fabricated by a printed circuit board process.

10. The method of claim 1, wherein the liquid fuel cell is a direct methanol fuel cell.

11. The method of claim 3, wherein the step (D) of generating the interpolation means comprises steps of:
(d1) utilizing the parameters of temperature, steady-state current and current overshoot measured from “n” kinds of fuels with known concentrations C₁, C₂, . . . , Cₙ to construct “n” items of corresponding equi-concentration curves in the three-dimensional measuring space;
(d2) providing a fuel with an unknown concentration C for the liquid fuel cell, and measuring instant parameters of temperature (T), steady-state current (I) and current overshoot (σ) of the liquid fuel cell, wherein the instant parameters of temperature (T), steady-state current (I) and current overshoot (σ) correspond to a measuring point P in the three-dimensional measuring space;
(d3) respectively projecting the measuring point P onto “n” items of equi-concentration curves along a steady-state current axis of the three-dimensional measuring space, resulting in “n” projecting points, wherein coordinate current values of the “n” projected points are separately expressed by Iᵢ, where i=1, 2, . . . n; and
(d4) using a formula below to calculate the fuel concentration C,
$$C = {\sum }_{k = 1}^{n} ( {\prod }_{{i = 1}_{i \neq k}}^{n} \frac{I - {I}_{i}}{{I}_{k} - {I}_{i}} ) \cdot {C}_{k}$$
wherein n≧2.
